(19) United States
(12) Patent Application Publication
(10) Pub. No.: US 2026/0071054 A1
(43) Pub. Date: Mar. 12, 2026

(54) HYBRID GRAPHENE NANOPLATELETS AND GLASS FIBERS POLYMER COMPOSITES

(71) Applicant: AXIOM GROUP INC., Aurora (CA)

(72) Inventors: Matthew LEROUX, Aurora (CA); Zahir Razzaz, Aurora (CA); Nello D. Sansone, Aurora (CA); Meysam Salari, Aurora (CA); Patrick C. Lee, Aurora (CA); Rafaela ANTUNES COSTA AGUIAR, Aurora (CA); Iman SOLTANI, Aurora (CA)

(21) Appl. No.: 19/104,081

(22) PCT Filed: Aug. 18, 2023
(86) PCT No.: PCT/IB2023/058292

§ 371 Date: Feb. 14, 2025

Related U.S. Application Data
(60) Provisional application No. 63/399,371, filed on Aug. 19, 2022.

(51) Int. Cl. C08K 9/06; C08J 3/20; C08J 3/22; C08K 7/00; H01M 50/122

(52) U.S. Cl. CPC C08K 9/06; C08J 3/201; C08J 3/226; C08K 7/00; H01M 50/122; C08J 2323/12; C08K 2201/003; C08K 2201/004; C08K 2201/011

(57) ABSTRACT

Provided is a polymer composite reinforced with graphene nanoplatelets and glass fibers, which may be prepared by injection molding. Molecular interactions between the graphene nanoplatelets and the glass fibers result in improved mechanical performance in the polymer composite. Synergistic effects are observed when the concentration of the glass fibers is over 20% and the concentration of the graphene nanoplatelets is between about 0.25% and about 1%.

### CROSS-REFERENCE TO RELATED APPLICATION

This application claims the benefit of U.S. Provisional Patent Application No. 63/399,371 entitled TAILORING MULTIFUNCTIONAL AND LIGHTWEIGHT HIERARCHICAL HYBRID GRAPHENE NANOPLATELET AND GLASS FIBER COMPOSITES, filed Aug. 19, 2022, the entire contents of which are incorporated herein by reference.

### FIELD

The present specification is directed to polymer composites and particularly hybrid polymers comprising graphene nanoplatelets and glass fiber reinforcement.

### BACKGROUND

Lightweighting is a strategy aimed at reducing the overall weight of vehicles and aircraft to enhance fuel efficiency and performance. In automotive and aerospace applications, every kilogram of weight reduction translates into fuel savings, increased range, and reduced emissions. Polymers, being lightweight and versatile materials, have become increasingly popular for lightweighting purposes. However, reinforcing materials are necessary to meet the mechanical and physical standards of automotive and aerospace applications in which both strength and functionality are required.

Hybrid composites comprising glass fiber and nanosized fillers have been explored to address drawbacks and shortcomings inherent to conventional biphasic single-fiber reinforced composites. Glass fibers and nanosized filler generally improve the mechanical properties of a polymer composite but approaches that merely rely on glass fibers for reinforcement can also reduce the flowability of the polymer composite while increasing the weight, brittleness, and cost. Nanosized fillers also have faced serious challenges in improving the strength.

### SUMMARY

An aspect of the specification provides a polymer composite including: a polymer matrix, greater than 20±1% by weight of the composite of glass fibers, and between about 0.25±0.01% to 1%±0.2% by weight of the composite of graphene nanoplatelets.

Another aspect of the specification provides a polymer composite including a polymer matrix, 40±2% by weight of the composite of glass fibers, and 0.5±0.025% by weight of the composite of graphene nanoplatelets, the graphene nanoplatelets bound to the glass fibers.

Another aspect of the specification provides an article having a polymer composite including: a polymer matrix, greater than 20±1% by weight of the composite of glass fiber, and between about 0.1±0.01% to 5%±1% by weight of the composite of graphene nanoplatelets.

Another aspect of the specification provides a method of preparing a polymer composite. The method includes blending a composition of polymer matrix, greater than 20±1% by weight of the composite of glass fibers, and between about 0.1±0.01% to 5%±1% by weight of the composite of graphene nanoplatelets. The method further includes extruding the composition and injecting the composition into a mold.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Embodiments are described with reference to the following figures.

FIG. 1A is a schematic diagram of graphene nanoplatelets coating a glass fiber, according to one embodiment.

FIG. 1B is a schematic diagram of a graphene nanoplatelet chemically binding to a glass fiber, according to another embodiment.

FIG. 1C is a schematic diagram of spherulitic crystals binding to graphene nanoplatelets coating a glass fiber, according another embodiment.

FIG. 2A is a method of preparing a polymer composite, according to an embodiment.

FIG. 2B is a flowchart depicting exemplary performance of method 200.

FIG. 2C is a flowchart depicting exemplary performance of method 200.

FIG. 3 is a graph comparing the FTIR spectra for un-sized GF, sized GF, and a hybrid composite of PP, GnP, and GF.

FIG. 4 is a graph comparing the XPS full spectra for un-sized GF, sized GF, and a hybrid composite of PP, GnP, and GF.

FIG. 5 is a graph comparing the high-resolution C1s region spectra for un-sized GF, sized GF, and a hybrid composite of PP, GnP, and GF.

FIG. 6 is a graph comparing the high-resolution N1s region spectra for un-sized GF, sized GF, and a hybrid composite of PP, GnP, and GF.

FIG. 7A is an SEM image of graphene nanoplatelets and glass fibers.

FIG. 7B is an SEM image of graphene nanoplatelets and glass fibers.

FIG. 7C is a POM image of graphene nanoplatelets and glass fibers.

FIG. 8A is an SEM image for the core region of Neat PP.

FIG. 8B is an SEM image for the core region of PPGF10.

FIG. 8C is an SEM image for the core region of PPGnP0.5.

FIG. 8D is an SEM image for the core region of PPGnP0.5GF10.

FIG. 9 is a thermogram for crystallization for example composites.

FIG. 10 is a thermogram for second heating for example composites.

FIG. 11 is a graph showing XRD diffractograms for example composites.

FIG. 12 is a graph of κ_{β} as a function of reinforcement concentration for example composites.

FIG. 13 is a graph of χ_{c} as a function of reinforcement concentration, for example composites.

FIG. 14 is a graph of the specific tensile strength versus reinforcement concentration for example composites.

FIG. 15 is a graph of flexural strength versus reinforcement concentration plots for example composites.

FIG. 16 is a graph of specific tensile modulus versus specific tensile strength for example composites.

FIG. 17 is a graph of effective synergistic effect versus specific tensile strengths and flexural strengths for example composites.

FIG. 18 is a graph of thermal conductivity versus reinforcement concentration for example composites.

FIG. 19 is graph of effective percent synergy versus reinforcement concentration for example composites.

FIG. 20A is a transverse (the upper one) and a longitudinal (the lower one) SEM image of a non-etched sample in concentrations of low GnP and low GF.

FIG. 20B is a transverse (the upper one) and a longitudinal (the lower one) SEM image of a non-etched sample in concentrations of low GnP and high GF.

FIG. 20C is a transverse (the upper one) and a longitudinal (the lower one) SEM image of a non-etched sample in concentrations of high GnP and low GF.

FIG. 20D is a transverse (the upper one) and a longitudinal (the lower one) SEM image of a non-etched sample in concentrations of high GnP and high GF.

FIG. 21A is a schematic diagram of the SEM image of FIG. 20A.

FIG. 21B is a schematic diagram of the SEM image of FIG. 20B.

FIG. 21C is a schematic diagram of the SEM image of FIG. 20C.

FIG. 21D is a schematic diagram of the SEM image of FIG. 20D.

### DETAILED DESCRIPTION

### Definitions

“About” herein refers to a range of +/−20% of the numerical value that follows. In one embodiment, the term “about” refers to a range of +/−10% of the numerical value that follows. In one embodiment, the term “about” refers to a range of +/−5% of the numerical value that follows.

“Bulk density”, “apparent density” and “volumetric density” are used interchangeably herein to refer to the weight of a volume unit of a divided substance such as powders and granules. Bulk density is calculated as the weight of a full container divided by the container volume.

“Composite” herein refers to a substance comprising two or more constituents.

“Filler” herein refers to any substance that is combined with a polymer to form a polymer composite. Fillers may be selected to improve properties of the composite such as tensile strength, flexural modulus, heat resistance, color, clarity, etc. There are two primary groups of fillers: particulates and fibers. In specific examples described herein, “filler” is used to describe glass fiber and graphene nanoplatelets.

“Flexural modulus” herein refers to the ability of a material to resist bending. Flexural modulus is measured as the ratio of stress to strain during flexural deformation.

“Graphene nanoplatelets” (or “GnP”) herein refers to a nanoparticle comprising planar sheets of graphene stacked on top of one another. GnPs typically have a thickness of 1-25 nm and range in width from 0.5 to 50 μm.

“Glass fiber” (or “GF”) herein refers to a substance comprising fine fibers of glass.

“Hybrid composite” herein refers to a polymer composite comprising two or more fillers.

“Inorganic filler” herein refers to any non-hydrocarbon that is combined with a polymer to form a polymer composite.

“Melt flow rate” herein refers to the ease of flow of the melt of a thermoplastic polymer. To calculate the melt flow rate, the polymer is made fluid by heating and forced to flow out of a cylinder through a capillary die under standard conditions. Melt flow rate is useful for comparing batches of the same material or to estimate flow properties of different materials.

“Polymer” herein refers to any macromolecule formed from repeating subunits known as monomers. When a macromolecule comprises two or more different types of monomers, it is known as a “copolymer”. When a macromolecule comprises a single type of monomer, it is known as a “homopolymer”.

“Polypropylene” (or “PP”) herein refers to a polymer formed from the monomer propene (also known as “propylene”) and having the general chemical formula (C₃H₆)ₙ.

“Specific gravity” and “relative density” are used interchangeably herein to refer to the density of a material relative to the density of water.

“Silanized” herein refers to a glass surface that has been treated with a silane agent resulting in a silane monolayer. During silanization, the hydroxyl groups on the surface of the silica are replaced by silyl groups.

“Tensile strength” herein refers to the maximum stress that a material can withstand while being stretched or pulled before breaking. Tensile strength is measured as force per unit area.

Disclosed herein is a polymer composite that includes a polymer matrix, an inorganic filler, and graphene nanoplatelets.

The polymer composite may further include one or more additives including but not limited to water, surfactant, dispersants, anti-foam agents, antioxidants, thermal stabilizers, light or UV stabilizers, light or UV absorbing additives, microwave absorbing additives, reinforcing fibers, conductive fibers or particles, lubricants, process aids, fire retardants, anti-blocking additives, crystallization or nucleation agents, and a combination thereof.

In the examples described herein, the polymer matrix is generally described as polypropylene, however other suitable polymers are contemplated including but not limited to polyethylene, polyamide, polyester, styrene acrylic, vinyl-acrylic, polyvinyl alcohol, polyolefins, polyurethane, polyvinylchloride, polystyrene, epoxy resin, phenoxy, vinyl ester, acrylate, polycarbonate, polyacetal, polybutylene terephthalate, acrylonitrile butadiene styrene, polyphenylene sulfide, polylactic acid, polyhydroxyalkanoates, polybutylene adipate terephthalate, polyoxymethylene, polyethyllene therephthalate, poly(methyl methacrylate), thermoplastic elastomers, and combinations including blends, copolymers, and terepolymers thereof.

In examples, where the polymer matrix comprises polypropylene, the polypropylene (PP) comprises a homopolymer or a copolymer. The polypropylene may have a melt flow rate of about 4 to about 70 g/10 min. In specific embodiments, the polypropylene has a melt flow rate of 30±2 g/10 min to 70±2 g/10 min and advantageously 50±2 g/10 min to 70±2 g/10 min.

In its granular form, the polypropylene may have a specific gravity between 0.895 g/cm³ and 0.94 g/cm³. In specific embodiments, the polypropylene has a specific gravity between 0.90 g/cm³ and 0.91 g/cm³ and advantageously 0.902±0.04 g/cm³.

A non-limiting example of the polypropylene is HIVAL® 2435 Neat PP, with a melt flow rate of 35±2 g/10 min (230° C./2.16 kg) and a specific gravity of 0.902±0.04 g/cm³ produced by Nexeo Plastics® (Texas, United States).

The inorganic filler comprises a particulate or fiber suitable for compounding with the polymer matrix. In the examples described herein, the inorganic filler comprises glass fibers, however other suitable fillers are contemplated including but not limited to glass beads, carbon fibers, Wollastonite, calcium carbonate, silica, clay, kaeolin, magnesium hydroxide, carbon, and combinations thereof.

Generally, the glass fibers have an average length between 1±0.05 mm and 20±1 mm. In specific embodiments, the glass fibers have an average length between 5±0.25 mm and 15±0.75 mm, advantageously between 8±0.4 mm and 12±0.6 mm, and more advantageously 12±0.6 mm.

Generally, the glass fibers have an average diameter between 4±0.2 μm. and 34±1.7 μm. In specific embodiments, the glass fibers have an average diameter between 10±0.5 μm to 20±1 μm, advantageously between 12±0.6 μm and 16±0.8 μm, and more advantageously 14±0.7 μm.

Silane groups may coat the outer surface of the glass fibers. The glass fibers may be pre-treated with a silane agent such that at least one silane group is covalently bonded to the surface of at least one of the glass fibers. Typically, silane agents bind to a hydroxyl group on the outer surface of a glass fiber. Silane groups may include Si—O—Si, Si—OCH₃, NH₂-silane, or Si—OR. but the silane groups are not particularly limited. Generally, the binding of the silane groups to the glass fibers functionalizes the glass fibers, increasing the affinity of the glass fibers to the graphene nanoplatelets. Glass fibers that are pre-treated with a silane agent may be referred to herein as “silanized” glass fibers.

The graphene nanoplatelets (GnPs) include an average of between about 1 to about 40 layers. In specific embodiments, the GnPs have an average of between about 6 to about 10 layers.

The GnPs may have a bulk density of about 0.02±0.001 g/cm³ to about 0.4±0.02 g/cm³. In specific embodiments, the GnPs have a bulk density of about 0.1±0.005 g/cm³ to about 0.2±0.01 g/cm³ and advantageously about 0.18±0.9 g/cm³. In a non-limiting example, the graphene nanoplatelets comprise GrapheneBlack™ 3X (NanoXplore Inc., Quebec, Canada). GrapheneBlack™ 3X has an agglomerate flake diameter of 10 to 70 and preferably, average of 38 μm, with approximately 6-10 layers, a bulk density of 0.18 g/cm³, and comprising less than 7 wt. % oxygen.

Herein, the composition of the polymer composite will be described by specifying the percentage of the weight of the polymer composite that comprises the glass fibers and the GnP. It should be understood that the remainder of the weight, although unspecific, comprises the polymer matrix.

Generally, the glass fibers comprise between about 15% and about 60% by weight of the polymer composite. In a preferred embodiment, the glass fibers comprise between 20±1% and 50±2.5% by weight of the polymer composite, advantageously between 40±2% and 50±2.5% by weight of the polymer composite, and more advantageously 40±2% by weight of the polymer composite.

Generally, the GnPs comprise between 0.1±0.001% and 5±0.5% by weight of the polymer composite. In a preferred embodiment, the GnPs comprise between 0.25±0.01% and 1±0.2% by weight of the polymer composite, and advantageously 0.5±0.025% by weight of the polymer composite.

Herein, the compositions of various embodiments will be denoted by indicating the polymer matrix, the amount of glass nanoplatelets by weight, and the amount of glass fiber (GF) by weight according to this format: PPGnP ζ GF ζ, where ζ corresponds to the amount of GF or GnP by weight. For instance, the biphasic composite containing 5 wt. % GnP is labelled as PPGnP5. Similarly, the hybrid composite containing 5 wt. % GnP and 10 wt. % GF is labelled as PPGnP5GF10.

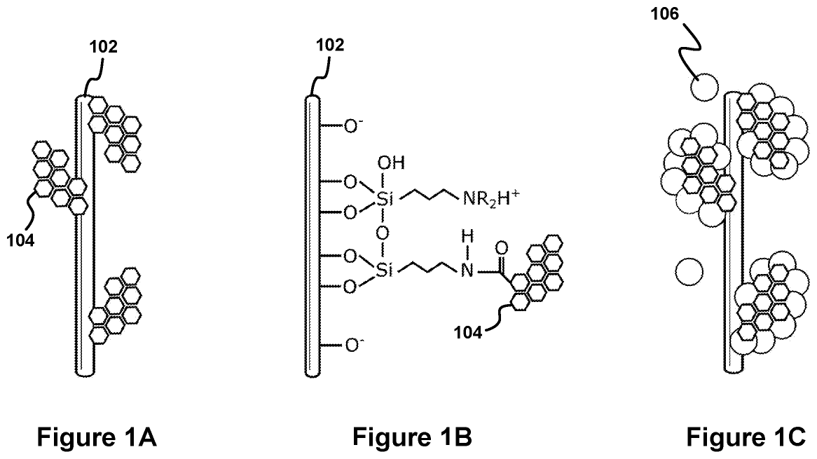

When the glass fibers are combined with the graphene nanoplatelets, the graphene may coat the glass fibers, as represented in FIG. 1A. FIG. 1A is a schematic diagram showing a plurality of graphene nanoplatelets 104 coating a glass fiber 102. The graphene nanoplatelets may coat the glass fibers via chemically bonding, electrostatic adherence, or a combination thereof. A mechanism by which the graphene nanoplatelets may chemically bind the glass fiber is shown in FIG. 1B. FIG. 1B is a schematic diagram illustrating a chemical bond formed between the graphene nanoplatelet 104 and an aminosilane group on the surface of the glass fiber 102, according to one non-limiting example. After crystallization, spherulitic crystals 106 of polypropylene form around the graphene nanoplatelets 104. FIG. 1C is a schematic diagram showing the binding of spherulitic crystals to the graphene nanoplatelets 104, according to one non-limiting example.

The glass fiber may bind to any suitable number of graphene nanoplatelets. In some examples, the graphene nanoplatelets form a coating on the surface of the glass fibers. In some examples, the graphene nanoplatelets encapsulate the glass fibers. The binding may be triggered when the glass fibers and graphene nanoplatelets are contacted under the high shear force imposed by the injection molding process.

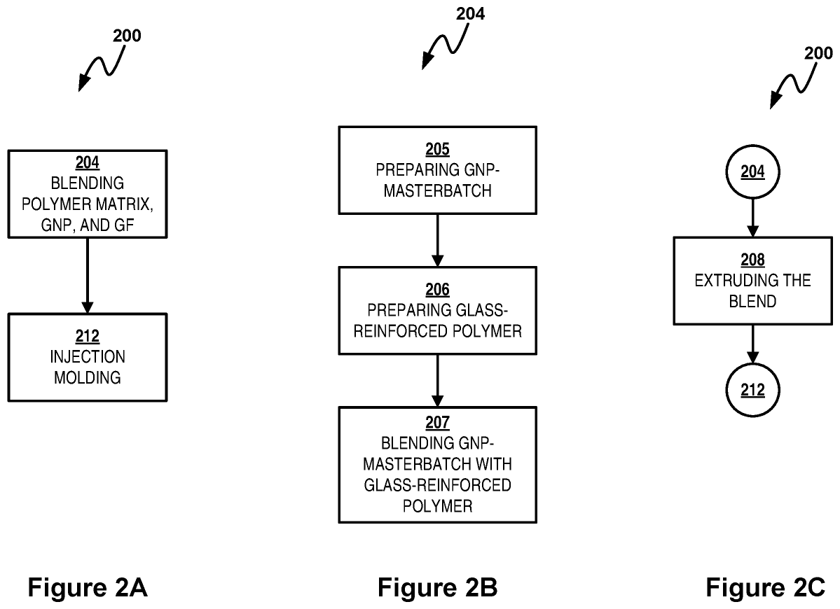

FIG. 2A shows a method 200 of preparing the polymer composite according to an example embodiment.

At block 204, the polymer matrix, glass fibers, and graphene nanoplatelets are blended together. A variety of blending of blending techniques are contemplated, including but not limited to dry blending and melt mixing. In preferred embodiments, the blending at block 204 is a melt mixing technique.

In some examples, the polypropylene, glass fiber, and graphene nanoplatelets are blended in a single blending step, however the method 200 is not particularly limited, and in other examples, the blending occurs in multiple stages. The order of blending the constituents is not particularly limited. In examples where the blending occurs in multiple stages, each blending stage comprise the same or different blending techniques.

In one embodiment, the graphene nanoplatelets are blended with the polymer matrix to form a polypropylene-graphene-nanoplatelet (PP-GnP) masterbatch which is subsequently blended with the glass fibers. In other embodiments, the glass fibers are blended with the polymer matrix to form a glass-reinforced polymer which is subsequently blended with the GnP. In further embodiments, the PP-GNP masterbatch is blended with the glass-reinforced polymer matrix. Additional polymer matrix may then be added to achieve the desired concentration of glass fiber and graphene nanoplatelets.

A specific non-limiting embodiment of block 204 is shown in FIG. 2B. FIG. 2B is a flowchart depicting exemplary performance of block 204 from FIG. 2A.

Block 205 comprises preparing a GnP-masterbatch. Block 205 may be performed by wet mixing or dry blending the graphene nanoplatelets with the polymer matrix. Suitable GnP-masterbatches may be commercially available, for example from NanoXplore Inc. (Quebec, Canada).

Block 206 comprises preparing a glass-reinforced polymer. Block 206 may be performed by wet mixing or melt mixing the glass fiber with the polymer matrix. Suitable glass-reinforced polymers may be commercially available. Non-limiting examples of a glass-reinforced PP include KompoGTe® LE1G60 and LE1G40 produced by Kolon Plastics (Gimcheon, South Korea) and Celstran® PP-GF60-02 Natural, produced by Celanese Corporation (Texas, United States). KompoGTe® LE1G60 comprises 60 wt. % of E-glass fibers with a specific gravity of 1.42 g/cm³. KompoGTe® LE1G40 comprises 40 wt. % of E-glass fibers with a specific gravity of 1.18 g/cm³. Celstran® PP-GF60-02 Natural comprises 60 wt. % of E-glass fibers having an average length of 10 mm and an average diameter of 14 μm, with an overall masterbatch density of 1.43 g/cm³.

Although FIG. 2B shows that block 205 is performed before block 206, blocks 205 and 206 may be performed in any order.

At block 207, the GF-reinforced PP mixture is blended with the graphene nanoplatelets. As part of block 207, additional polymer matrix may be added to achieve a desired concentration of glass fiber and graphene nanoplatelets.

As shown at block 208 in FIG. 2C, the blend obtained at block 204 may be extruded. FIG. 2C is a flowchart depicting exemplary performance of method 200. At block 208, the blend comprising the polymer matrix, the glass fiber, and the graphene nanoplatelets is extruded. Block 208 is performed by an extruder. A non-limiting example of an extruder is a Leistritz® twin-screw extruder (27 mm, L/D: 40) (Leistritz, Nuremberg, Germany). The melt extrusion temperature may be selected according to the polymer matrix. Generally, the melt extrusion temperature is between 100±5° C. to 350±18° C. In a specific embodiment, the extrusion process is conducted at 45±2 RPM with a temperature profile of 140±7° C. to 190±10° C. Returning to FIG. 2A, block 212 comprises injection molding and is performed by an injection molding machine. Block 212 may be performed on the blend obtained at block 204 using an injection molding machine that both heats and mixes the blend. In embodiments where the blend is extruded, block 212 is performed on the extrusion obtained at block 208. A non-limiting example of an injection molding machine is a 50-ton Arburg Allrounder™ 270/320C injection molding machine (Lossburg, Germany) with a 30 mm diameter screw. In certain other non-limiting examples, the injection molding machine is equipped with MuCell® Technology (Trexel Inc., Woburn, Massachusetts).

The mold temperature may be selected according to the polymer matrix. Generally, the mold temperature is between 40±2° C. and 180±9° C. In a specific embodiment, the injection is conducted at a mold temperature of 80±4° C. In another specific embodiment, the injection is conducted at a mold temperature of 65±4° C.

Reducing the mold temperature may decrease the molding processing cycle time. In one non-limiting example, the mold temperature is 80° C. and the injection molding processing time is 123 seconds. In another non-limiting example, the mold temperature is 65° C. and the injection molding processing time is 93 seconds. While the shorter processing cycle may sacrifice crystallization degree in the small articles, for a large article (such as a battery encasement), the cooling time is sufficiently high to allow appropriate crystallization to happen and to improve the properties of the final article. As such, reducing the mold temperature can decrease the overall time and cost of manufacturing an article.

The mold may be shaped to form pellets comprising the polymer composite or to form an article. In examples where the mold is shaped to form pellets, the pellets may be sized and shaped to be used in subsequent injection molding to form an article. In examples where the mold is shaped to an article, the article is not particularly limited. Examples articles include but are not limited to automotive parts, aerospace parts, packaging, construction materials, and electronics. In specific examples, mold is shaped to form a component for a vehicle such as an automotive vehicle or an aerospace vehicle. In particular examples, the mold is shaped to form an encasement for a battery.

Articles formed from the polymer composite exhibit improved thermal conductivity, flexural strength, tensile strength, stiffness-to-weight ratios, and strength-to-weight ratios. Thus, vehicles assembled with components comprising the polymer composite demonstrate improved fuel efficiency.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

The polymer composite will now be described with respect to the examples herein.

### Example 1

### 1.1 Materials and Methods

### 1.1.1 Materials and Sample Preparation

A commercially available polypropylene (PP) homopolymer, HIVAL® 2435, with a melt flow rate of 35 g/10 min (230° C./2.16 kg) and a specific gravity of 0.902 g/cm³ produced by Nexeo Plastics® (Texas, United States) was used as the polymer matrix. The glass-filled polypropylene masterbatch, with commercial name Celstran® PP-GF60-02 Natural, produced by Celanese Corporation (Texas, United States), was filled with 60 wt. % of E-glass fibers sized with a proprietary formula of aminosilane, having an average length of 10 mm and an average diameter of 14 μm, with an overall masterbatch density of 1.43 g/cm³. The graphene nanoplatelets (GnPs), with commercial name GrapheneBlack™ 3X, was provided by NanoXplore Inc. (Quebec, Canada), having an average flake diameter of 38 μm, with approximately 6-10 layers, and a bulk density of 0.18 g/cm³.

The PP-GF composites with various GF concentrations were prepared by diluting the as-received Celstran® PP-GF60-02 Natural masterbatch with the as-received HIVAL® 2435 Neat PP using a dry blending technique in order to avoid damage and/or breakage of the GF's. The PP-GnP composites with various GnP concentrations were prepared by melt-mixing the as-received GrapheneBlack™ 3X powder and the as-received HIVAL® 2435 Neat PP in a Leistritz® twin-screw extruder (27 mm, L/D: 40) (Nuremberg, Germany), in order to ensure thorough mixing of the nanomaterial. The extrusion process was conducted at 45 RPM with a linear temperature profile across the 10 heating zones, from 140° C. (feeding) to 190° C. (die). The hybrid composites were prepared by mixing the previously diluted blends from the biphasic composites into the desired concentrations, through the dry blending.

A 50-ton Arburg Allrounder 270/320C injection molding machine (Lossburg, Germany), with a 30 mm diameter screw equipped with MuCell® Technology (Trexel Inc., Woburn, Massachusetts) was used to fabricate the composite samples at a mold temperature of 80° C. The samples were injected into a custom dual tensile and flexural mold, designed to create ASTM D638—Type IV standard and ASTM D790 standard specimens, respectively.

The composites were designated by indicating the matrix, the amount of GnP, and the amount of GF according to this format: PPGnP ζ GF ζ, where the ζ corresponds to the amount of reinforcing material by weight of the whole composite. For instance, the biphasic composite containing 5 wt. % GnP is labelled as PPGnP5. Similarly, the hybrid composite containing 5 wt. % GnP and 10 wt. % GF is labelled as PPGnP5GF10. Additionally, all of the prepared and fabricated samples are tabulated with respect to their reinforcement concentrations in Table 1.

TABLE 1

| Sample Name | T_{c} (° C.) | Tₘ (° C.) | ΔT (° C.) | (X_{c})_{DSC} | (X_{c})_{XRD} |
|---|---|---|---|---|---|
| Neat PP | 120 | 162 | 42 | 49 | 50 |
| PPGnP0.25 | 125 | 164 | 39 | 51 | 51 |
| PPGnP0.5 | 126 | 164 | 38 | 55 | 56 |
| PPGnP1 | 126 | 164 | 38 | 53 | 53 |
| PPGF10 | 122 | 162 | 41 | 52 | 50 |
| PPGF20 | 121 | 165 | 44 | 51 | 52 |
| PPGF30 | 121 | 165 | 44 | 51 | 52 |
| PPGF40 | 121 | 164 | 43 | 52 | 50 |
| PPGF50 | 121 | 163 | 42 | 51 | 50 |
| PPGF60 | 123 | 167 | 44 | 52 | 52 |
| PPGnP0.5GF10 | 125 | 164 | 39 | 55 | 56 |
| PPGnP0.5GF20 | 125 | 164 | 39 | 55 | 56 |
| PPGnP0.5GF30 | 125 | 164 | 39 | 55 | 55 |
| PPGnP0.5GF40 | 125 | 164 | 39 | 56 | 56 |
| PPGnP0.5GF50 | 125 | 164 | 38 | 55 | 55 |

### 1.1.2 Morphological and Crystallographic Characterization

The molecular interactions and chemical adhesion were assessed using Fourier-Transform Infrared Spectroscopy (FTIR) and X-Ray Photoelectron Spectroscopy (XPS), on the as-received sized GFs obtained from the PPGF60 masterbatch and on the fabricated hybrid composite PPGnP0.5GF40, which were both almost completely etched in boiling Xylene for 1-hour to remove the PP matrix. Additionally, the un-sized GFs were collected by placing the sized GFs in a high-temperature oven at 600° C. for 2 hours, to remove the aminosilane surface modification. The instrument used for FTIR was a Bruker Platinum-ATR (Bruker, Billerica, United States) with a spectral range of 500-4000 cm⁻¹, and the instrument used for XPS was a high-resolution Thermo Fisher Scientific™ K-Alpha (Thermo Fisher, Waltham, United States).

The electrostatic interactions between the GnP, un-sized GFs, and sized GFs were evaluated using the Brookhaven Instruments Corporation ZetaPlus™ Zeta Potential Analyzer (Brookhaven Instruments Corporation, Holtsville, New York, United States) with deionized water (PH˜7) as the common solution and red laser light source (660 nm wavelength).

The microstructure and crystalline morphologies of PP composites were investigated using a Phenom ProX™ Scanning Electron Microscope (SEM) (Thermo Fisher, Waltham, United States). The fabricated injection molded composites were cryo-fractured by immersing the samples in liquid nitrogen for approximately 1-hour. Then, select samples were partially etched in boiling Xylene for 5 minutes, to better visualize the crystalline morphology, without dissolving the entire PP matrix. Finally, the composites were sputter-coated with platinum before observation in the SEM. Additionally, an Olympus™ BX51P Polarized Optical Microscope (POM), equipped with a Linkam™ Scientific Instruments Ltd. Hot-stage (THMSG600) and an Olympus™ U-TP530 wave plate, was used to observe the crystalline morphologies under a Nitrogen (N₂) atmosphere. Thin films of ˜50 μm were heated from room temperature to 250° C. at a rate of 10° C./min, at which they were held isothermally for 5-minutes to fully melt the PP crystals and remove all thermal history. Then, the samples were rapidly cooled at a rate of 50° C./min to 140° C., in order to minimize the formation of crystals during this cooling step and held isothermally for 10 minutes to allow the PP composites to fully crystallize. Select composites were analyzed using this temperature profile, at which images were captured every 5 seconds, to compare the nucleation densities observed with varying composite morphology. Furthermore, Image J software (National Institutes of Health, Bethesda, MD, USA) was used to quantify the crystal nucleation densities from the POM images and approximate the crystal spherulite diameters from the SEM images of etched specimens.

The crystallization kinetics of the composites were evaluated using non-isothermal Differential Scanning calorimetry (DSC, TA Instruments DSC 250) under an inert N2 atmosphere at atmospheric pressure. First, the samples were equilibrated at −50° C. and then heated at a rate of 10° C./min to 250° C., at which they were held isothermally for 5 minutes to remove all thermal history. The samples were then cooled back to −50° C. at a rate of 10° C./min and held isothermally for 5 minutes. This moderate cooling rate was selected to observe the effect of the reinforcing materials on the crystal growth and polymorphism independently, as a higher cooling rate can affect the crystal polymorphism of PP. Finally, the samples were heated again to 250° C. at a rate of 10° C./min. The crystallinity of the composites was calculated from the DSC thermograms using Formula 1:

$${( {χ}_{c} )}_{DSC} = \frac{Δ {H}_{f}}{ϕΔ {H}_{0}} \times 100 \% \qquad Formula 1$$

In Formula 1, ΔH_{f} is the measured enthalpy of fusion of the sample, ΔH₀ is the enthalpy of fusion for perfectly (100%) crystalline PP (ΔH₀=209 J/g) [25], and φ is the weight fraction of PP.

The crystalline microstructures of the composites were assessed using 1D-X-Ray Diffraction (1D-XRD). The instrument used was a D8 Davinci™ diffractometer (Bruker, Billerica, United States) with a Cobalt-sealed tube (λ=1.79026 Å) parallel beam line source (0.2 mm slit, 2.5° Soller) and an Eiger2 R 500K area detector (Dectris, Philadelphia, United States) in 1D mode (2.5° Soller, 2θ 10°, γ 2θ) with a 0.02° step size and 30 min scans of 2θ from 10° to 60° in reflection mode. The crystallinity of the composites was calculated from the 1D-XRD diffractogram using Formula 2.

$${( {χ}_{c} )}_{XRD} = \frac{{H}_{c}}{{H}_{c} + {H}_{a}} \times 100 \% \qquad Formula 2$$

where H_{c} is the intensity of the crystalline peaks, and Hₐ is the intensity of the amorphous peaks. The β-phase fraction formed was characterized by Formula 3, according to the method of Turner-Jones et al. (A. T. Jones and J. Aizlewood, “Crystalline forms of isotactic polypropylene,” Die Makromol. Chemie, vol. 75, no. 1, pp. 134-158, 1964, doi: 10.1002/macp. 1964.020750113; P. Juhász, J. Varga, K. Belina, and & G. Belina, “Efficiency of β-nucleating agents in propylene/α-olefin copolymers,” J. Macromol. Sci. Part B, vol. 41, pp. 1173-1189, 2002, doi: 10.1081/MB-120013090).

$${𝒦}_{β} = \frac{{H}_{β ( 300 )}}{{H}_{β ( 300 )} + {H}_{α ( 110 )} + {H}_{α ( 040 )} + {H}_{α ( 130 )}} \times 100 \% \qquad Formula 3$$

In Formula 3, H_{α(110)}, H_{α(040)}, H_{α(130)} are the intensities of the (110), (040), and (130) diffraction peaks of the α-form, respectively, and HB (300) is the intensity of the (300) peak of the β-form.

### 1.1.3 Mechanical Properties

The specific tensile mechanical properties of Neat PP and the fabricated composites were measured in accordance with the ASTM D638 and ASTM D792 standards, using an Instron® 5965 (Instron, Norwood, United States) with a load cell of 5 kN at a crosshead speed of 5 mm/min, and a gauge length of 25 mm, as well as an analytical balance with a precision of 0.1 mg for the density measurements, all at ambient conditions, and the material densities. Prior to testing, the samples were kept at atmospheric conditions for at least 48 hours. At least five replicate samples were tested, and the average values with corresponding standard deviations were obtained.

The flexural mechanical properties of Neat PP and the fabricated composites were measured in accordance with the ASTM D790 standard, using an Instron® 5965 (Instron Norwood, Massachusetts, United States) with a load cell of 5 kN at a crosshead speed of 1.3 mm/min, and a span length of 48 mm at ambient conditions. Prior to testing, the samples were kept at atmospheric conditions for at least 48 hours. At least three replicate samples were tested, and the average values with corresponding standard deviations were obtained.

### 1.1.4 Thermal Conductive Properties

Thermal conductivity measurements for Neat PP and the fabricated composites were conducted using the transient hot disk method, according to ISO/DIS 22007-2.2. A transient plane source (TPS 2500, Therm Test Inc., Sweden) thermal constants analyzer with a Kapton sensor (C7577) was employed to measure the thermal conductivity of the samples under ambient conditions. In this method, an electrically conductive double spiral disk-shape sensor made of nickel foil is placed in between two identical samples with planar surfaces. The sensor works as both a heater and a dynamic thermometer to simultaneously increase and record the temperature variations in the samples as a function of time. The isotropic measurement module was used to measure the bulk/average thermal conductivity of the fabricated samples. Therefore, the values were calculated by measuring the dissipated heat in all directions (i.e., both in-plane and through-plane).

### 1.1.5 Synergistic Effect Evaluation

A quantitative method to evaluate the synergistic effect, or percent synergy was used to determine the improvement in the mechanical properties of a composite due to the co-supporting network within various composites. Formula 4, defined below, takes into account the varying concentration of the matrix between hybrid composites and compensates for the changing filler loadings:

$${S}_{E}^{\%} = \frac{k - ( p + q )}{( p + q )} \times 100 \% \qquad Formula 4$$

In Formula 4, k represents the magnitude of the enhancement of the hybrid composite relative to the matrix material, and p and q represent the magnitude of the enhancements of the individual reinforcing materials alone relative to the matrix material.

It is important to note, that this equation eliminates the baseline enhancement of the matrix without eliminating the enhancement due to the interaction of the fillers with the matrix material, as this is known to contribute to the synergistic effect. A positive S_{E}^{%} is indicative of a synergistic enhancement generated within the hybrid composite, while a negative S_{E}^{%} suggests a discord within the hybrid system resulting in an undesirable decrease in its properties.

### 1.2 Results and Discussion

### 1.2.1 Morphology and Interfacial Interactions

In order to understand the interfacial interactions between the glass fibers and the graphene nanoplatelets within the hybrid composites, the physical, chemical, and electrostatic interactions were investigated. (Herein, the glass fibers may be referred to as “micro-sized filler” and the graphene nanoplatelets may be referred to as “nano-sized filler”. The glass fibers and the graphene nanoplatelets may be referred to collectively as “fillers”.) The physical interactions are associated with the composite's morphology, whereby the GFs induce a volume exclusion effect. This effect physically constrains the motion of the graphene nanoplatelets within the hybrid mixture as it rapidly flows into the mold cavity, during the injection molding process. As a result, the graphene nanoplatelets inevitably accumulate and align themselves around the glass fibers. This physical interaction is more significant at the melt front, whereby the fountain effect disturbs the orientation of the fillers. Further discussion on the physical interaction involving the volume exclusion effect and correlated microstructure is elucidated in Section 2.4 (Mechanical Properties and Synergistic Effect Elucidation).

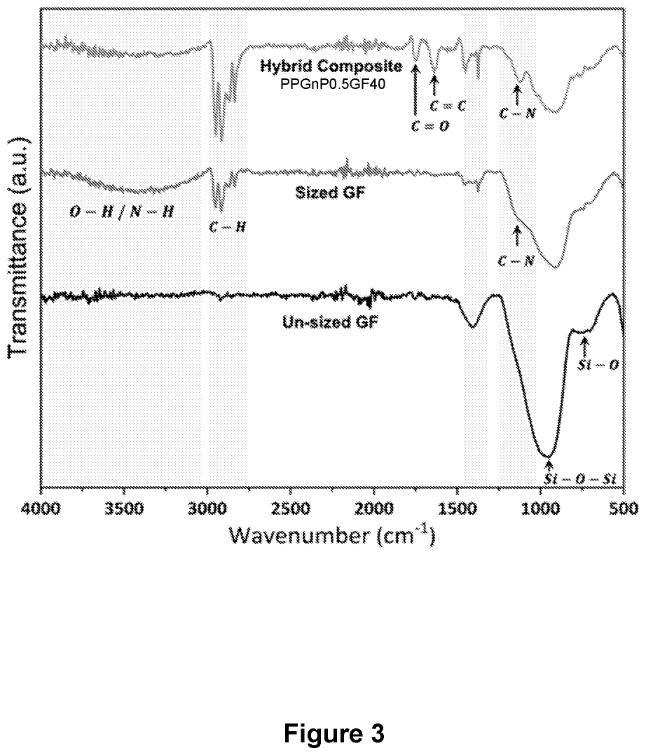

FIG. 3 shows the FTIR spectra of unsized GF, sized GF, and a hybrid composite (PPGnP0.5GF40). Note: The PP matrix in the hybrid composite PPGnP0.5GF40 was almost completely etched, to expose the proposed hierarchical reinforcement structure.

The chemical interfacial interactions relate to the chemical bonding of the GnPs onto the sized GFs (i.e., chemically modified surface with aminosilane), thereby forming a desirable reinforcement system, known as a hierarchical structure. Generally, hierarchically structured composites, that are chemically bonded (or grafted) and/or electrostatically attached, are known to provide greater mechanical properties and functionalities compared to those that only possess physical interactions. The FTIR spectra in FIG. 3, showcase the variabilities in the chemical structure of the un-sized and sized GFs, as well as the interfacial interaction of the sized GFs in the presence of GnPs within the hybrid composites. The un-sized GF spectrum illustrates the characteristic broad bands inherent to GF, with the Si—O—Si stretching peak at 1,000 cm⁻¹ and the Si—O bending peak at 730 cm⁻¹, as well as the onset of the Si—O rocking vibrations peak normally around 450 cm⁻¹. The sized GF spectrum is comprised of the same characteristic peaks as the un-sized GF, with the addition of the broad band from 3,000-3,850 cm⁻¹ inherent to amine N—H stretching and/or intermolecular O—H bonding, which are representative of the sizing. Furthermore, the peaks at 1,376, 1,456, 2,870, 2,920 and 2,950 cm⁻¹ are related to CH₂ and CH₃ bonds, and the shoulder present at 1,125 cm⁻¹ is indicative of the presence of amine C—N stretching.

The hybrid composite spectrum, represented by PPGnP0.5GF40 (almost completely etched PP), shows an increase in the CH₂ and CH₃ bond peaks, which is a result of the remaining PP matrix that is primarily composed of these chemical bonds. The emergence of the peaks at 1,760 cm⁻¹ and 1,638 cm⁻¹ correspond to the C═O stretching and C═C stretching bonds, respectively, which are associated with graphene 47,50-52. Additionally, the evolution of the peak at 1,125 cm⁻¹ could be indicative of an increase in C—N bonding within the hybrid composites, which would suggest the formation of a chemically bonded hierarchical structure. Moreover, the reduction in the broad band from 3,000-3,850 cm⁻¹ reveals a clear trade-off of the N—H and O—H bonding, to favor C—N bonding between the carbon atoms along the surface of the GnPs and nitrogen atoms along the surface of the sized GFs. In other words, these results imply that the increased C—N bonding can be attributed to the electrophilic carbon atoms on the GnPs that form new C—N bonds with the GF's sizing.

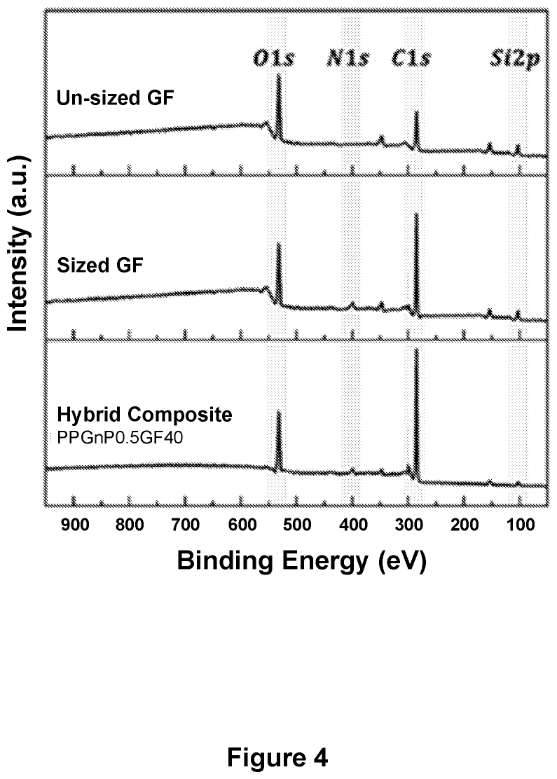

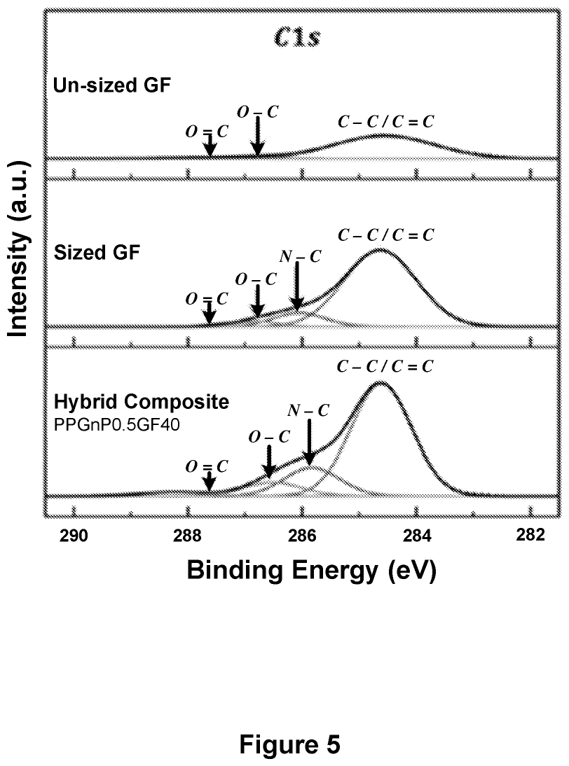

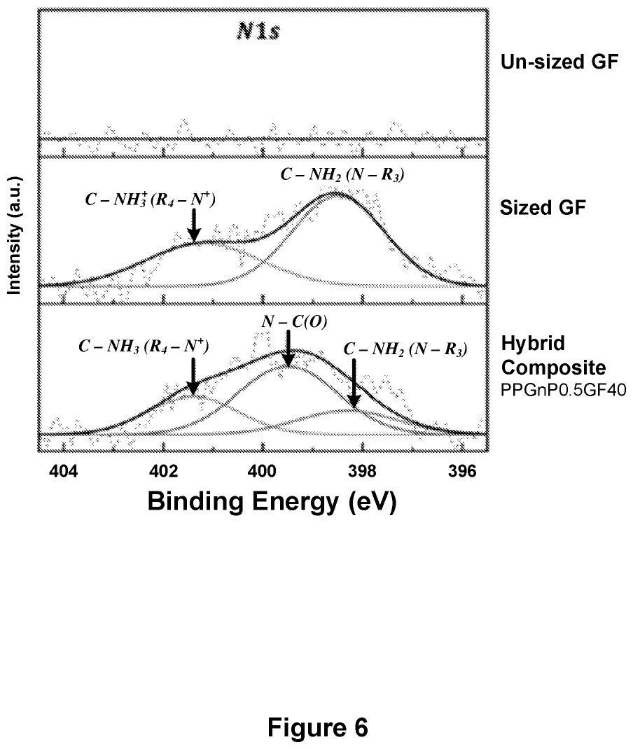

XPS was conducted to analyze the surface chemical composition of the un-sized and sized GFs, as well as to validate the FTIR results that suggest the formation of a covalently bonded hierarchical structure within the hybrid composites. Additionally, XPS was conducted on the as received GnPs. FIGS. 4 to 6 show the XPS full-spectra, high-resolution C1s region spectra, and high-resolution N1s region spectra, for the un-sized GF (top), sized GF (middle), and PPGnP0.5GF40 (bottom). Note: The PP matrix in the hybrid composite PPGnP0.5GF40 was almost completely etched, to expose the proposed hierarchical reinforcement structure. As shown in FIGS. 4 to 6, the XPS results for the sized GF and hybrid composite spectra, indicate a distinct N1s peak at ˜400.1 eV, while undetectable in the un-sized GF spectra, confirming the presence of amino functional groups within the sizing. The high-resolution C1s peaks were deconvoluted into four specific peaks: C—C or C—H bonds (˜284.6 eV), C—N bonds (˜286.1 eV), C—O bonds (˜286.8 eV), and C═O bonds (˜287.7 eV). The C—N bond intensity for the hybrid composite is greater than that of the sized GF, while it is not present for the un-sized GF, directly correlating to the FTIR results.

For the sized GF, two chemical bonding peaks were deconvoluted and attributed to protonated (˜401.3 eV) amine groups in the form of N⁺—R₄ (a result of the NH2-silane groups reacting with the OH groups on the GF's surface and/or other silane molecules) and non-protonated (˜398.4 eV) amine groups in the form of N—R₃. The majority of the amino groups within the sized GF were found to be non-protonated, implying that they are free amino groups oriented away from the GF's surface and are readily available to react. For the hybrid composite, an additional bonding peak at ˜399.5 eV is evident, which is indicative of the formation of amide bonds, along with the protonated (˜401.3 eV) and remaining non-protonated (˜398.4 eV) amine groups 56,57. Simply, the emergence of the amide (N—C(O)) peak at ˜399.5 eV along with the decrease in intensity of the non-protonated amine (N—R₃/NH₂) peak at ˜398.4 eV, demonstrates that the carboxylic acid groups (R—COOH) on the GnPs' surface have reacted with the non-protonated amine groups on the sizing to produce amide bonds, thereby creating a hierarchical reinforcement structure. The driving force for this chemical reaction may be promoted during the injection molding process, whereby the hybrid mixture is subjected to high shear and extensional deformation at elevated temperatures, combined with (1) the volume exclusion effect induced by the GFs, that physically constrains the motion of the GnPs, and (2) the presence of an electrostatic affinity between the reinforcements.

The electrostatic affinity between the reinforcements was characterized using Zeta Potential measurements, highlighting the electrostatic charge of the un-sized GFs, sized GFs, and GnPs. The un-sized GFs have a negative electrostatic charge of −9 mV, the sized GFs have a positive electrostatic charge of +32 mV, induced by the aminosilane surface modification, and the GnPs have a negative electrostatic charge of −38 mV, due to the ionization of the remaining oxygen-containing functional groups on the surface of the GnPs. It is evident that the GnPs and sized GFs have opposite charges, therefore, this facilitates their assembly under electrostatic interactions, creating a hierarchical interface.

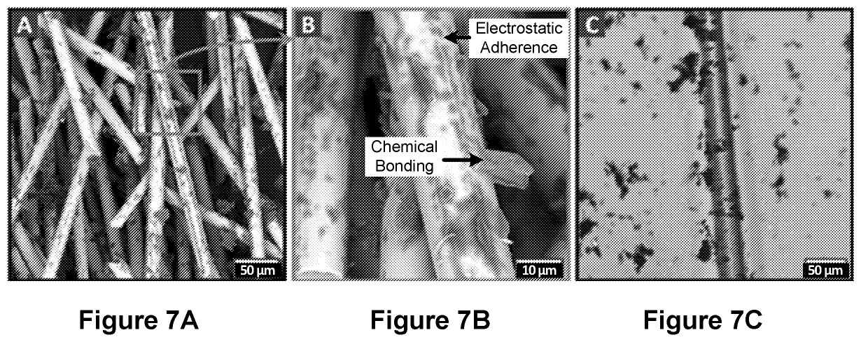

FIGS. 7A and 7B are SEM images of the chemical bonding and electrostatic adhesion of the GnPs onto the sized GFs. FIG. 7C is a POM image highlighting the hierarchical reinforcement structure in the hybrid composite.

The hierarchical reinforcement system is illustrated in the SEM images of FIGS. 7A and 7B and previously shown in the schematic of FIG. 1, whereby the GnPs are shown to coat the GFs, emphasizing the combined effect of electrostatic adherence and chemical bonding. Further proving the effects of these mechanisms, the POM image for the hybrid composite of FIG. 7C showcases a similar pattern, whereby the majority of the GnPs are encapsulating the GFs, with minimal GnPs dispersed in the bulk of the matrix. As a result, these images provide sufficient evidence to support the presence of interfacial interactions and the mechanisms for the successful formation of a hierarchical hybrid composite system. The following sections will overview the structure-property relations of these hybrid composites, with a focus on how varying concentrations of the reinforcements affects the crystalline morphology, in order to optimize the synergistic effect and bulk properties.

### 1.2.2 Crystalline Microstructure and Crystallization Behavior

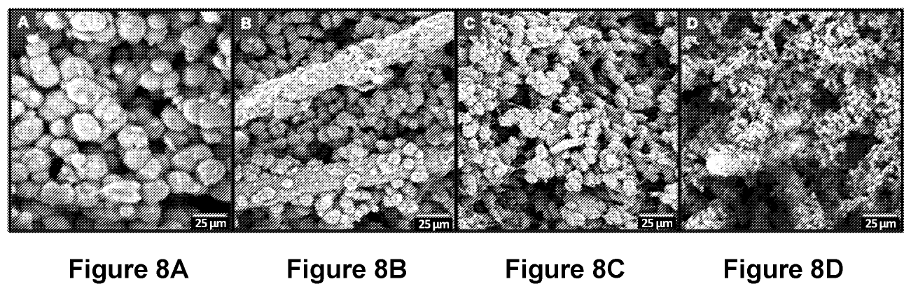

FIGS. 8A to 8D are SEM images for the core region of Neat PP (FIG. 8A), PPGF10 (FIG. 8B), PPGnP0.5 (FIG. 8C), and PPGnP0.5GF10 (FIG. 8D).

The SEM images for select etched composites, illustrated in FIGS. 8A to 8D, provide insights into the varying crystalline morphology. The etched amorphous regions in FIG. 8A, display the spherulitic crystal growth of Neat PP, whereby the average crystal diameter is ˜17 μm. For PPGF10, shown in FIG. 8B, the average crystal diameter is ˜10 μm. These smaller crystals are a result of the increased nucleation density (2.60 ‘1010 nuclei/cm²), leading to an ˜48% increase relative to Neat PP (1.76’ 1010 nuclei/cm²). Similarly, for PPGnP0.5, shown in FIG. 8C, the average crystal diameter is ˜8 μm due to the increased nucleation density (4.08·10¹⁰ nuclei/cm²) resulting in an ˜132% increase relative to Neat PP. The hybrid composite PPGnP0.5GF10, shown in FIG. 8D, contains the smallest average crystal diameter of ˜3 μm, owing to the highest nucleation density (5.46·10¹⁰ nuclei/cm²) which is ˜210% greater than Neat PP.

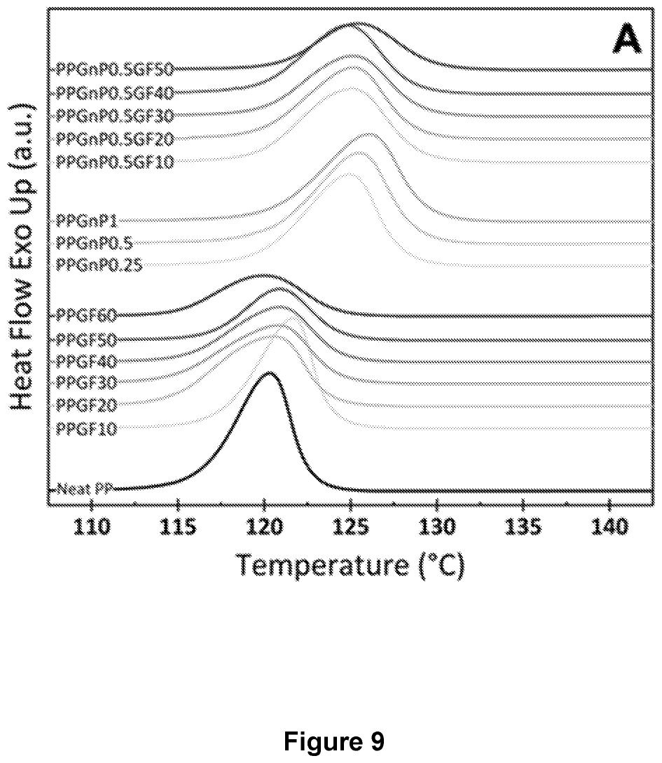

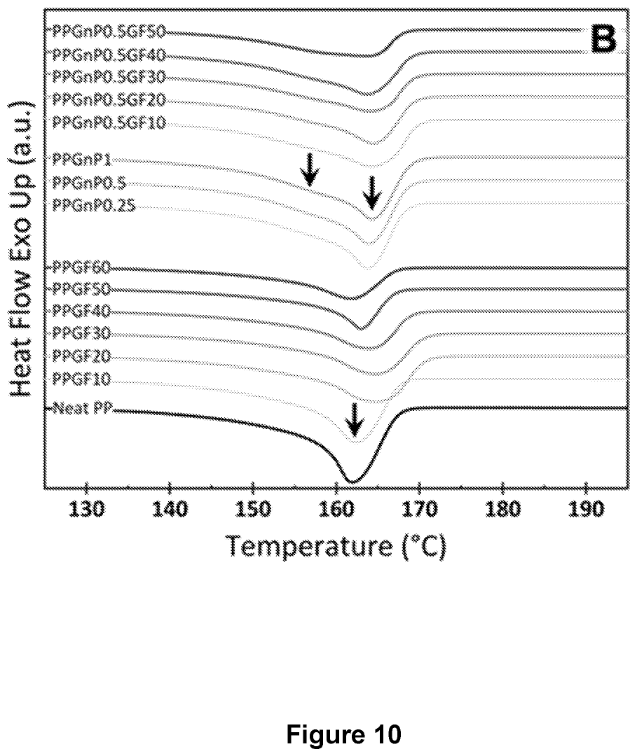

FIGS. 9 and 10 are thermograms for crystallization (FIG. 9) and second heating (FIG. 10) for select fabricated composites, highlighting the bimodal crystallization behavior for the samples containing GnPs. For the biphasic composites reinforced with GnP, the crystallization temperature (T_{c}) increased with increasing amounts of filler, indicating that the crystallization of PP was accelerated in the presence of GnPs. An increase in T_{c} corresponds to a decrease in the degree of super-cooling (ΔT=Tₘ−T_{c}), whereby the degree of super-cooling is proportional to the free energy of melting. Since the free energy of melting is associated with the driving force for nucleation, a decrease in the degree of super-cooling implies that crystallization was achieved at a lower driving force, as GnPs act as seeds for heterogeneous nucleation. Furthermore, the crystallinity increased from 49% (Neat PP) to a maximum of 55% for the PPGnP0.5 composite, shown previously in Table 1. The crystallization thermograms are indicative of unimodal curves, while the second melting thermograms display a bimodal pattern, whereby the greatest shoulder is seen for PPGnP0.5.

On the contrary, for the biphasic composites reinforced with GF, the T_{c} was not affected with increasing concentration of GF. The invariable T_{c} demonstrates that the presence of GF does not lower the driving force for nucleation, as the inferior aspect ratio, when compared to GnP, results in less preferred sites for heterogeneous nucleation.

The DSC thermograms for the hybrid composites, show that they inherit the crystallization behavior of the biphasic GnP composites of the same concentration. Specifically, T_{c} increased with increasing concentration of GnP regardless of GF concentration, further proving that GnP is the dominating factor affecting the crystallization behavior. Moreover, a similar trend is observed for the (χ_{c})_{DSC}, in which the hybrid composites inherited the crystallinity of the biphasic GnP composites with the same concentration, whereby the maximum (χ_{c})_{DSC} of ˜55% was observed with 0.5 wt. % GnP for all concentrations of GF. While the crystallization thermograms show a unimodal pattern, the second melting thermograms display bimodal curves, similar to what was observed in the GnP biphasic composites. However, for the hybrid composites with constant GnP content, increasing the concentration of GF makes the bimodal pattern less prominent. Since these bimodal curves can be indicative of the existence of crystals other than the most common α-form, XRD was conducted to elucidate the crystalline microstructure inherent to these composites.

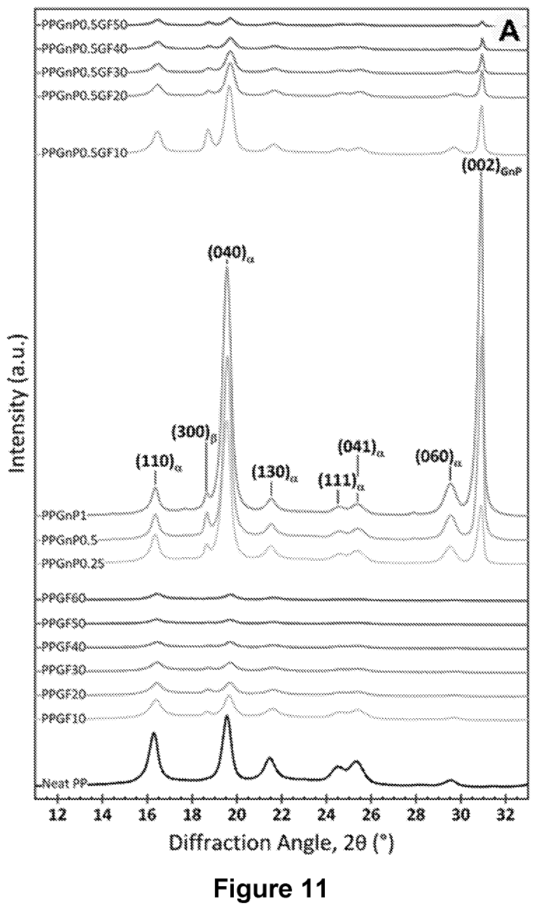

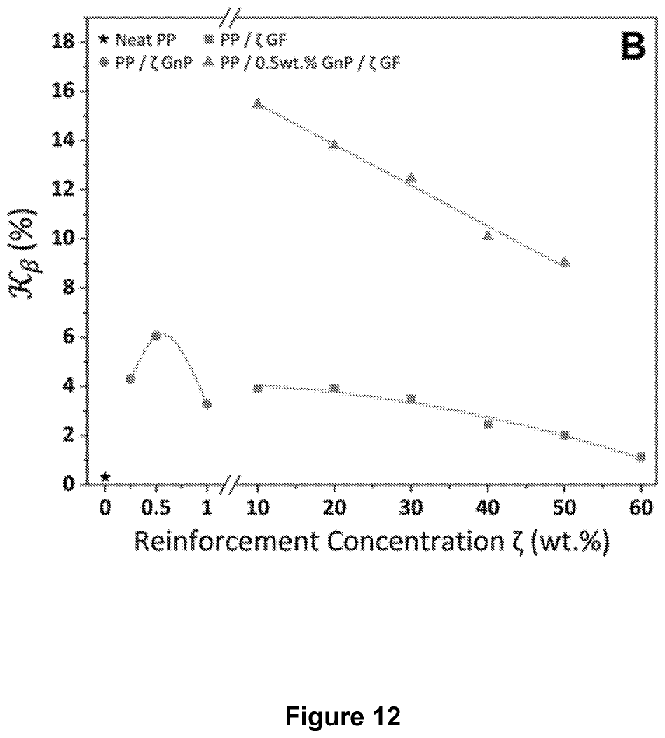

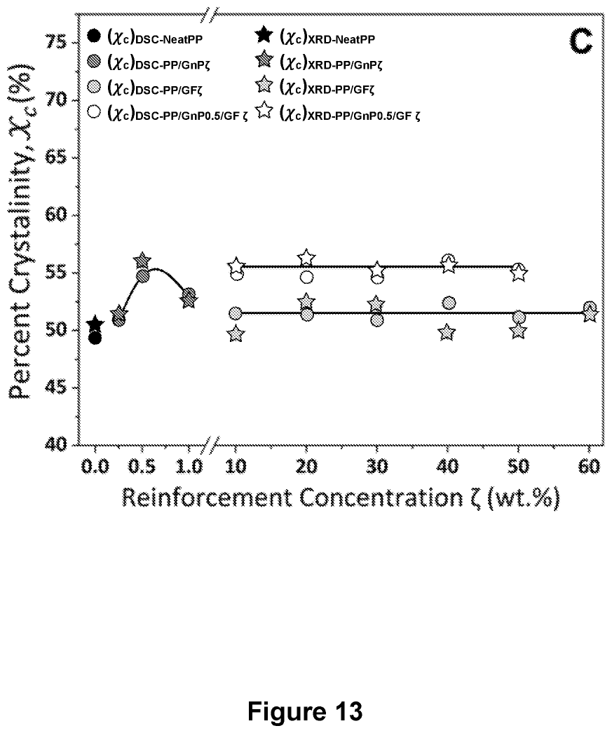

FIG. 11 shows XRD diffractograms for select fabricated composites. FIG. 12 shows κ_{β} as a function of reinforcement concentration. FIG. 13 shows χ_{c} as a function of reinforcement concentration, for select fabricated composites. Note that the trendlines are only present to guide the reader.

The XRD scattering patterns for the biphasic and hybrid composites, shown in FIG. 11, emphasize the efficacy of the different reinforcements to alter the crystalline microstructure of Neat PP. Specifically, the presence of the (300)_{β} crystallographic plane is indicative of β-crystals in the crystalline microstructure. Since the melting temperature of β-crystals is approximately 10.9° C. lower than α-crystals, the presence of these crystals explains the shoulder observed on the DSC melting peaks in FIG. 9. Generally, β-crystals provide excellent mechanical properties, such as toughness, tensile strength, elongation at break, and impact strength, compared to α-crystals and can be induced by different processing conditions through: shear-induced crystallization, directional crystallization in a temperature gradient field, vibration-induced crystallization, and the addition of specific nucleating agents.

During a conventional injection molding process with a room temperature mold, the polymer melt experiences high shear stresses near the mold cavity walls. Hence, shear-induced crystallization and directional crystallization in a temperature gradient field, from the skin to the core region of the mold, are the conditions favoring β-phase formation for the samples containing GF. However, a mold with an elevated temperature of 80° C. was used in this study. Therefore, the effect of the temperature gradient field is relatively less pronounced, suggesting that shear-induced β-phase crystallization is the dominant mechanism. As a result, the β-phase can be initiated by growth transformations along the oriented α-phase front. The total fraction of β-phase formed within these composites is highlighted using the semi-quantitative KB method, as shown in in FIG. 12. For the biphasic GF composites, with <30 wt. % GF, κ_{β} was constant at ˜4%, while the composites with >30 wt. % GF decreased with increasing concentration. Since the GFs used in these examples are estimated to have a thermal conductivity of 1.3 W/m×K, which is approximately 6 times higher than that of the Neat PP matrix (see Section 2.4), the thermal conductivity of the composite would be enhanced as the concentration of GF increases. Therefore, the heat of the composite will be dissipated at a higher rate, so that the polymer melt experiences a lower temperature during crystallization within the mold cavity. This effect could lead to a shift of T_{c} to domains below the lower critical temperature for the formation of the β-phase (T_{αβ}), at which the α-phase growth rate is dominant. Moreover, secondary crystallization occurs when the polymer melt is cooled below T_{αβ}, which is attributed to the α-phase growing on the β-phase during cooling, as α- and β-crystals are based on the same helix geometry. These effects explain why KR steadily decreases, as the concentration of GF increases, beyond 30 wt. % GF. This decreasing trend of KB, from ˜16% to ˜9%, is more significant for the hybrid composites. This can be attributed to the significantly higher thermal conductivity of the GnPs, resulting in a further shift of T_{c}.

Additionally, for the biphasic GnP composites, the presence of β-crystals is enhanced due to the addition of GnPs which act as β-nucleating agents. The optimum formation of KR was found in PPGnP0.5, where it reached a maximum of 6%. The dispersion and distribution of the GnPs is reduced within polymer composites containing >0.5 wt. % GnP, as they form agglomerates due to the strong IT-IT interactions and van der Waals forces. As such, the agglomerates reduce the heterogeneous nucleation efficiency of the GnPs. Also, it is important to note that the (χ_{c})_{DSC} and (χ_{c})_{XRD} are in strong accordance with each other, emphasizing the reliability of the experiments and characterization processes.

The XRD diffractograms for the hybrid composites depict the variations in crystalline microstructures, with different reinforcement concentrations. The intensity of the GnP crystallographic plane (002)_{GNP}, is suppressed with the introduction of GF, implying that the volume exclusion effect imparted by the GFs, provides a mechanism for a more effective dispersion and distribution of the GnPs, compared to their biphasic counterparts. A maximum κ_{β} of ˜16% was found in PPGnP0.5GF10, which is greater than the additive sum (κ_{β}=˜10%) of PPGnP0.5 and PPGF10, demonstrating a clear synergistic effect. Therefore, the tailored crystalline microstructure that promotes the formation of β-crystals is a result of the heightened dispersion and distribution of the GnPs, induced by the volume exclusion effect. However, κ_{β} decreases with increasing concentration of GF, suggesting that the reduced volume of crystallizable material allows for the rigid body motion of the GnPs to constrain the movement and alignment of the PP chains more effectively, thus limiting the further formation of β-crystals. Another hypothesis is that the melt material, within the mold cavity, is subjected to a shorter period of time within a temperature range favourable for β-phase formation, since the heat dissipation rate of the melt material increases proportionally with increasing GF content.

Additionally, based on the XRD patterns shown in FIG. 11, the (002)_{GnP}: crystallographic plane increases exponentially, as the GnP content increases. This is accompanied with an increase and decrease in the intensities of the (040)_{α} and (110)_{α} crystallographic PP planes, respectively, emphasizing the effectiveness of GnP in promoting trans-crystallization. The proposed model for the governing mechanism of trans-crystallization is based on the epitaxial growth (i.e., perpendicular) of α-crystals on the surface of the platelets. Furthermore, the GnP c-axis would merge with the PP b-axis in such a way that the (002)_{GnP}: plane is matched with the (010)_{α} PP planes, specifically the (040)_{α} and (060)_{α} planes. The effect of the reinforcements to induce epitaxial growth is quantified by considering the ratio of (040)_{α} and (110)_{α} intensities (i.e., I_{(040)α}/I_{(110)α}). For instance, I_{(040)α}/I_{(110)α} increases to 7.92 and 3.18 for PPGnP0.5 and PPGnP0.5GF10, respectively, relative to Neat PP (1.28). However, for the GF-reinforced biphasic counterpart (i.e., PPGF10) this ratio is equal to 1.25, indicating that GF has no effect on epitaxial growth of PP. As a result, the successful formation of trans-crystals within the hybrid composites promotes load transfer from the PP matrix to the hierarchically structured reinforcement system, leading to the mechanical properties enhancements described in the following section.

### 1.2.3 Mechanical Properties and Synergistic Effect Elucidation

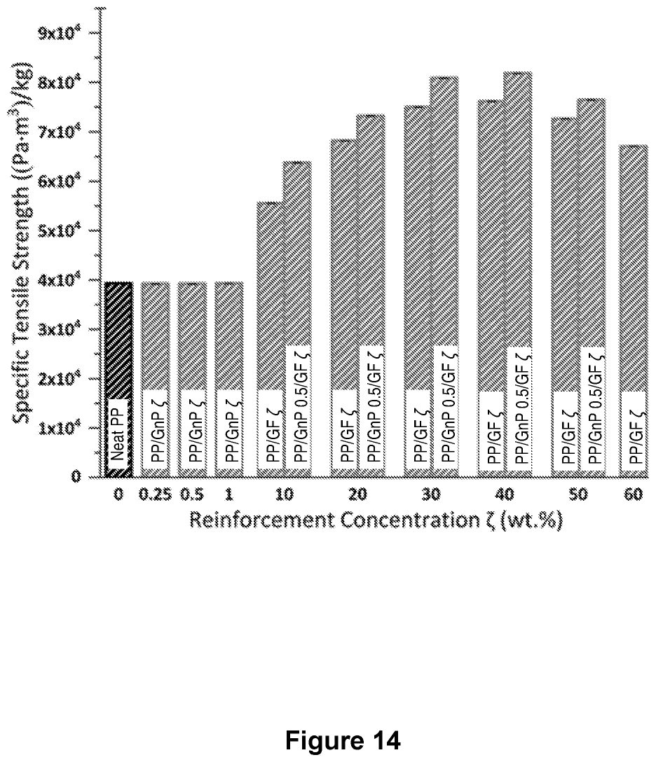

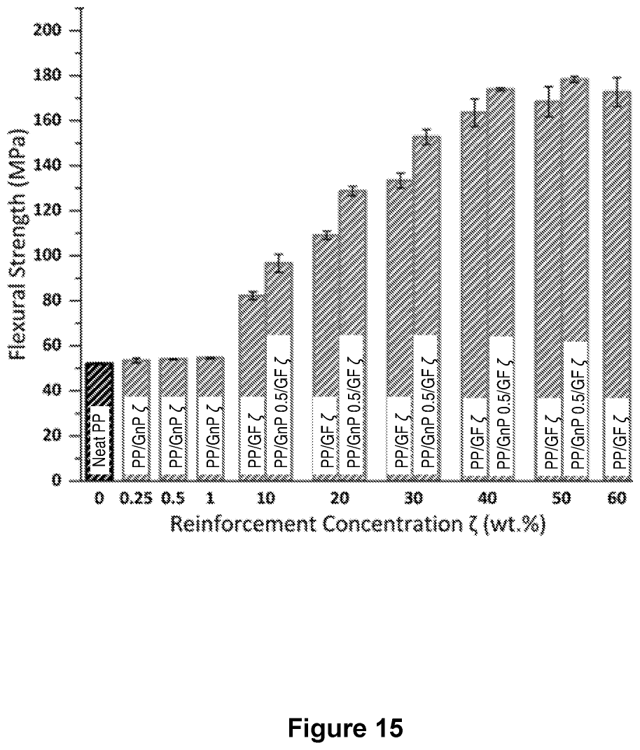

The specific tensile strength and flexural strength were evaluated for all of the fabricated samples, in order to highlight the degree of enhancement generated by the individual fillers in the biphasic composites, and the degree of enhancement generated by the combination of fillers in the hybrid composites. The results for select samples are displayed in FIGS. 14 and 15, in which the ζ represents the concentration by weight of the corresponding reinforcement, as indicated by the legend.

FIG. 14 is a graph of specific tensile strength versus reinforcement concentration plots for select fabricated composites. FIG. 15 is a graph of flexural strength versus reinforcement concentration plots for select fabricated composites.

The specific tensile and flexural strengths of the hybrid composites containing £ 1 wt. % GnP, perform better than the corresponding biphasic composites with the same concentration of GF. In particular, an optimum concentration of GnP is observed in the hybrid composites with 0.5 wt. % GnP, yielding the highest specific tensile strength of 8.18′104 (Pa×m³)/kg for PPGnP0.5GF40 and flexural strength of 178 MPa for PPGnP0.5GF50. In order to validate the efficacy of these hybrid composites, PPGF60 was selected as a baseline, as it is used for high-performance automotive applications. For example, PPGnP0.5GF50 exceeds the specific tensile and flexural strengths of PPGF60 by 14% and 3.3%, respectively, while providing a 9% weight reduction. Furthermore, PPGnP0.5GF40 obtained a specific tensile strength of 22% greater than PPGF60 and the same desirable flexural strength, while providing an 18% weight reduction.

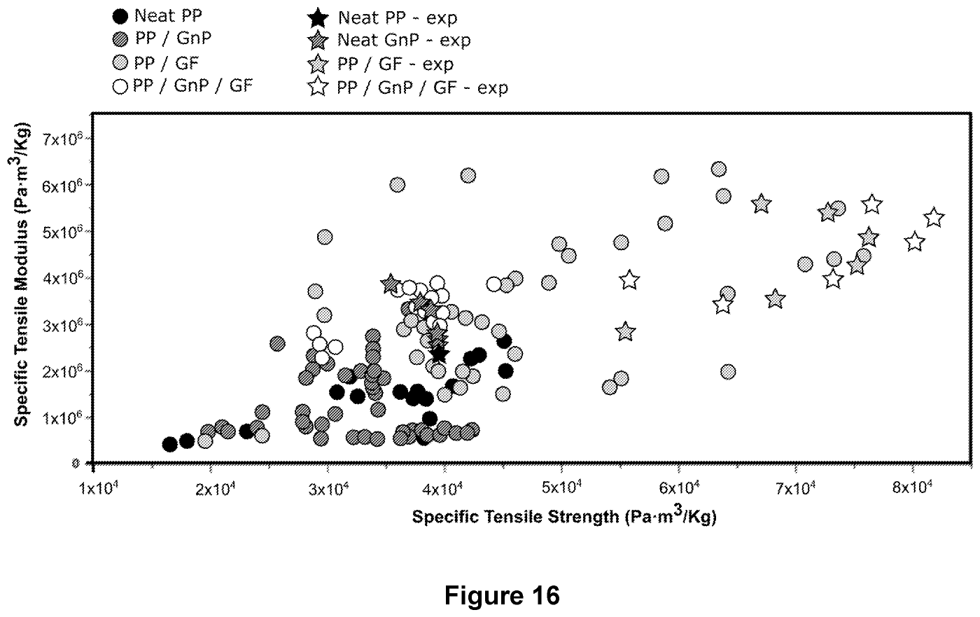

FIG. 16 is a material selection chart for specific tensile modulus versus specific tensile strength of collected literature data with superimposed experimental results.

The material selection chart, shown in FIG. 16, showcasing the specific tensile modulus versus specific tensile strength for collected literature data and the experimental data presented in this work, emphasizes the effectiveness of this hybrid system on lightweighting. This is attributed to the advantageous stiffness-to-weight and strength-to-weight ratios of these composites. It is observed that the optimum performing composite is PPGnP0.5GF40, whereby its stiffness-to-weight (5.57×10⁶ (Pa×m³)/kg) and strength-to-weight (8.18×10⁴ (Pa×m³)/kg) ratios are maximized. In general, it can be observed that the hybrid composites presented in this work outperform the specific tensile properties of the ones previously published in literature, with comparable GF concentrations (i.e., ≤20 wt. %). For example, PPGnP5GF10 presented in this work exceeds the previously recorded literature value, for the same hybrid system and concentration of fillers, by 26.5%, and PPGnP0.5GF10 presented in this work exceeds it by 44% while using significantly less GnP.

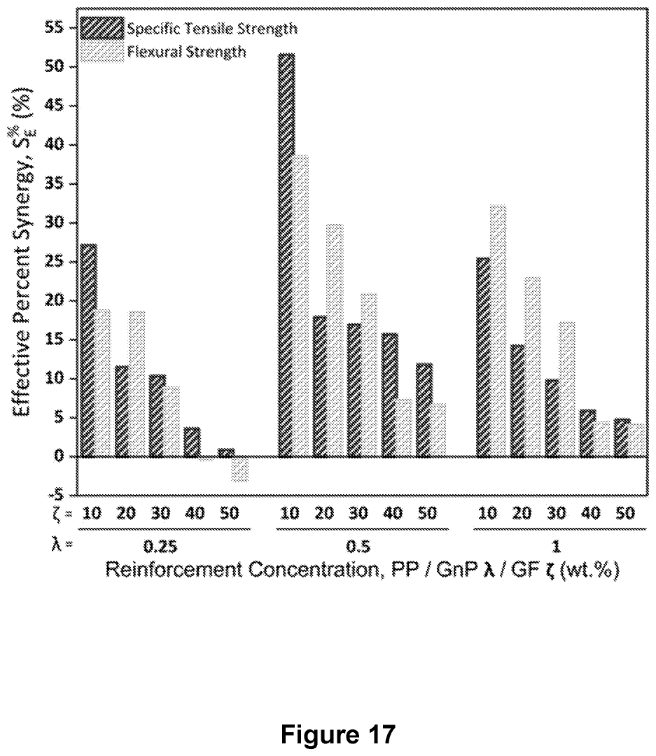

FIG. 17 is a graph showing the effective synergistic effect for the specific tensile strength and flexural strengths of select hybrid composites.

The synergistic effect, in the mechanical properties of these hybrid composites, can be attributed to the implementation of optimum concentrations of the two geometrically different reinforcements, thereby creating a hierarchically structured reinforcement system with improved interfacial interactions that facilitate load transfer and simultaneously enhance the crystalline microstructure of the matrix. It has been demonstrated that creating a hierarchical structure, between the micro-sized filler and the matrix material, with the addition of nano-additives, facilitates better interfacial stress transfer, leading to improved mechanical properties. This is attributed to the high-aspect ratio of the nano-sized fillers, leading to improved bonding at the interface, as a result of the increased surface area. In this work, it has been demonstrated that during processing the GnPs become chemically bonded and/or electrostatically attached to the sized GFs, thereby creating a hierarchical structure. This hierarchical structure promotes greater load transfer from the matrix to the GFs, due to the greater surface area of the improved interface, leading to an increased degree of trans-crystallization, as schematically illustrated in FIG. 1 and elucidated by the XRD results FIG. 11. Trans-crystallization has been shown to favorably improve the interface between fillers and matrix materials owing to absorption/adsorption of polymer chains along the fillers, promoting the translation of stress. Furthermore, the trans-crystallization encapsulating the hierarchical structure induces crystallites that are ˜70% smaller than those of the biphasic GF composites, as illustrated in FIGS. 8A to 8D. The larger specific surface area of these refined crystallites consume more energy when subjected to strong mechanical forces, leading to improved stress transfer at the interface. As a result, the synergistic effect is directly correlated to the tailored interface within these hybrid composites, resulting in superior mechanical performance.

Additionally, the action of GnPs as seeds of heterogeneous nucleation promoting the formation of β-crystals nucleation. As previously mentioned, β-crystals are known to provide excellent mechanical properties, compared to α-crystals. Generally, as a load is applied to the β-crystals, beyond the yield strength, the banded lamellae start to separate and de-fold, undergoing a B to a phase transition. This results in an increase in strength due to the mechanisms of strain hardening, as well as an increased resistance against crack propagation.

The effective percent synergy (S₁%) was evaluated for the hybrid composites to elucidate the trends associated with the various combinations of filler loadings, as shown in FIG. 17 for the specific tensile and flexural strengths of select samples. For the specific tensile and flexural strengths, the S₁% for the hybrid composites with constant GnP concentration decreases with increasing concentration of GF. The optimum S₁% was found in the hybrid composites with 0.5 wt. % GnP at all GF concentrations, in which hybrid composites with <0.5 wt. % GnP and hybrid composites with >0.5 wt. % GnP have a lower S₁%. As a result, the maximum S₁% is approximately 52% and 39% for the specific tensile strength and flexural strength of PPGnP0.5GF10, respectively.

According to the DSC thermograms shown in FIGS. 9A and 9B and XRD diffractograms shown in FIG. 11, the maximum formation of β-crystals and crystallinity occurs with GnP concentrations of 0.5 wt. %. Since the maximum S₁% for the mechanical properties of the hybrid composites also occurs with 0.5 wt. % GnP, the enhanced mechanical performance must be directly correlated to the formation of β-crystals and increased overall crystallinity. Thus, the decrease in mechanical performance for the hybrid composites with GnP concentrations above 0.5 wt. % may be a result of the greater degree of agglomeration, combined with a lower content of the β-phase. Furthermore, the synergistic effect decreases with increasing GF concentration, corresponding to the decreasing trend of κ_{β}.

It is evident that there are two main mechanisms of improvement that contribute to the synergistic effect of this hybrid system: (1) The creation of a hierarchically structured reinforcement system that directly improves the mechanical properties by facilitating load transfer at the interface due to the increased degree of trans-crystallization as a result of the greater surface area in contact with the PP matrix, and (2) the development of a crystalline microstructure with increased crystallinity and β-crystal formation, enabling the matrix to absorb a substantial amount of energy and promote the stress transfer to the reinforcements when exposed to strong mechanical forces.

### 1.2.4 Thermal Conductive Properties and Synergistic Effect Elucidation

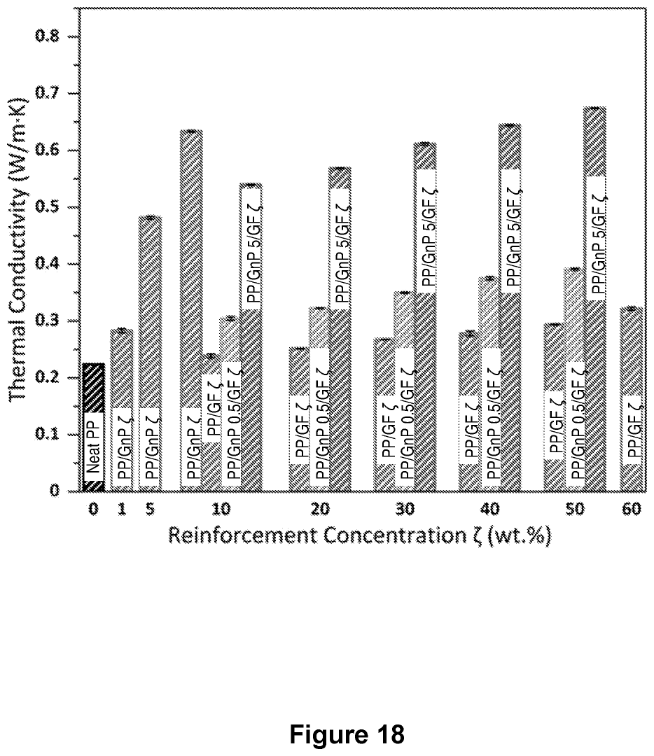

The thermal conductivity was evaluated for all fabricated samples, in order to highlight the degree of enhancement generated by the individual fillers in the biphasic composites, and the degree of enhancement generated by the combination of fillers in the hybrid composites. The results for select composites are displayed in FIG. 18, in which the ζ represents the concentration by weight of the corresponding reinforcement, as indicated by the legend.

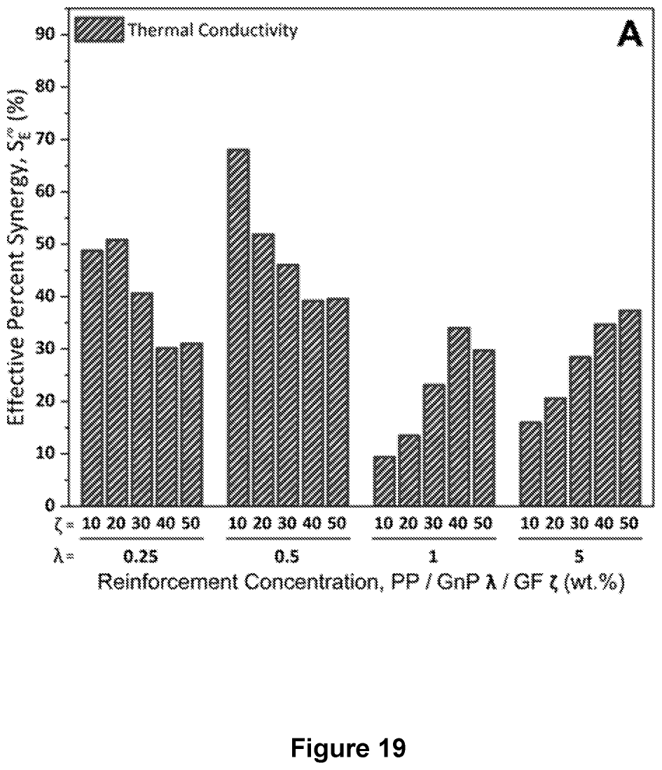

FIG. 18 shows the thermal conductivity data for select composites, and FIG. 19 shows the effective synergistic effect for the thermal conductivity of all fabricated composites.

As expected, increasing the concentration of GnP in the biphasic composites, increased the thermal conductivity, while increasing the concentration of GF had minimal effect on its biphasic composites. Specifically, the biphasic composites with 10 wt. % reinforcement, show a thermal conductivity improvement of 183% with GnP and 7% with GF, compared to Neat PP. This high thermal conductivity in the biphasic GnP composites is attributed to the large surface area of the GnPs, due to their high aspect ratios, enabling them to easily form bridges of percolating networks. As a result, the thermal conductivity increases significantly with increasing GnP concentration, as phonon transfer through the conductive pathways is facilitated.

While the maximum thermal conductivity improvement for the biphasic GnP composites occurred in PPGnP10, the maximum thermal conductivity improvement for the biphasic GF composites occurred in PPGF60, with a 44% increase relative to Neat PP. The thermal conductivity of the hybrid composites with 5 wt. % GnP, show the greatest improvement compared to those of the biphasic composites with the same GnP concentration. Specifically, PPGnP5GF50 has the highest thermal conductivity, exceeding that of PPGnP10 by approximately 6.5% and increasing that of Neat PP by 201%.

The S₁% was evaluated, as shown in FIG. 11 (B), for the thermal conductivity of the hybrid composites to elucidate the trends associated with the various combinations of filler loadings. S₁% for the thermal conductivity with constant GnP concentrations ≤1 wt. %, decreases with increasing concentration of GF. However, for the composites with constant GnP concentrations >1 wt. %, the S₁% increases with increasing concentration of GF. The optimum S₁% was found in the hybrid composites with 0.5 wt. % GnP at all GF concentrations. However, the increasing trend with higher concentrations of GnP (i.e., >1 wt. %), suggests that there could be an optimum S₁% beyond the data presented in this work. Overall, the maximum S₁% is approximately 68% corresponding to PPGnP0.5GF10.

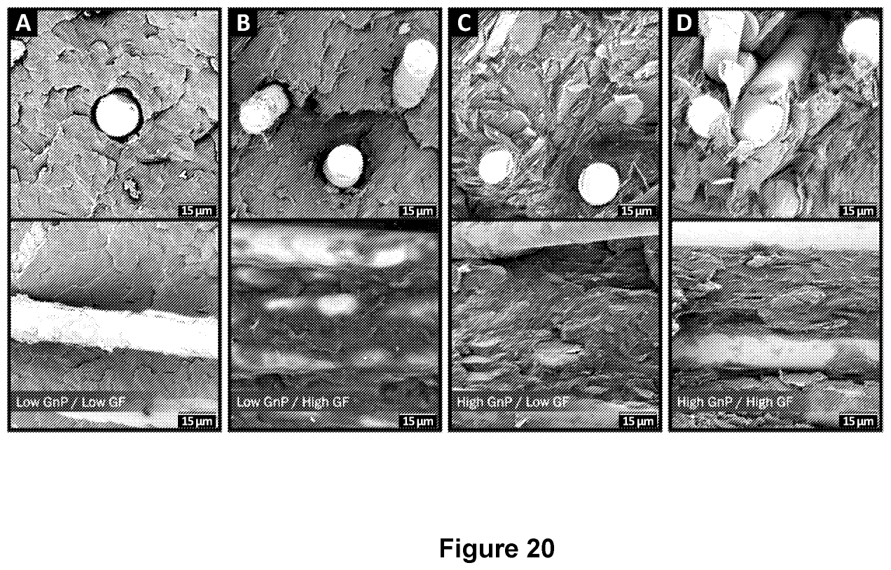

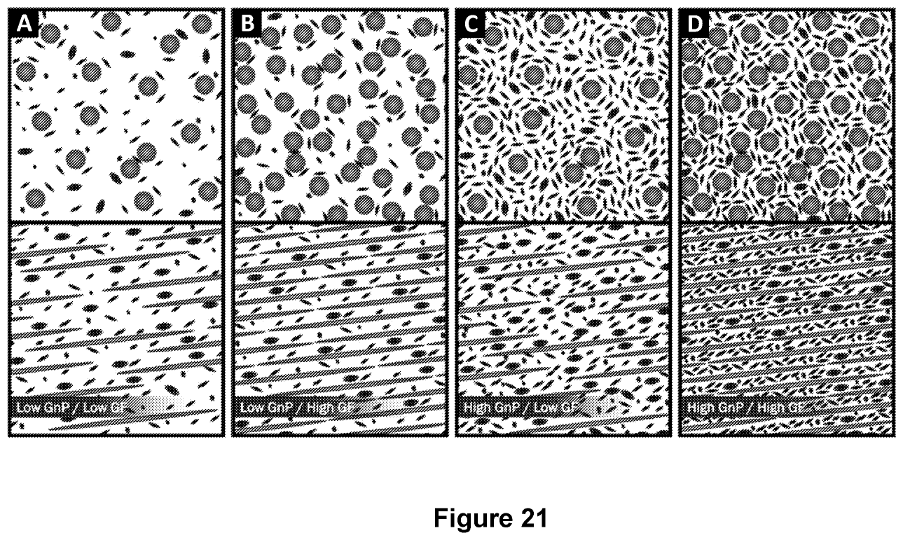

The synergistic effect of the thermal conductivity is primarily attributed to the implementation of optimum concentrations of the two geometrically different reinforcements. This leads to a tailored composite morphology that promotes the formation of thermal conductive pathways, with the crystalline microstructure playing a supporting role. The conductive pathways are generated through the volume exclusion effect induced by the presence of the GFs within the hybrid composites. The four scenarios associated with this behavior are captured in the SEM images shown in FIG. 20 and schematically shown in FIG. 21.

FIG. 20A is a transverse (the upper one) and a longitudinal (the lower one) SEM images of a non-etched sample in concentrations of low GnP and low GF. FIG. 20B is a transverse (the upper one) and a longitudinal (the lower one) SEM image of a non-etched sample in concentrations of low GnP and high GF. FIG. 20C is a transverse (the upper one) and a longitudinal (the lower one) SEM image of a non-etched sample in concentrations of high GnP and low GF. FIG. 20D is a transverse (the upper one) and a longitudinal (the lower one) SEM image of a non-etched sample in concentrations of high GnP and high GF.

FIGS. 21A to 21D are schematics illustrating the mechanisms of thermal conductive synergy via the volume exclusion effect. FIG. 21A depicts concentrations of low GnP and low GF, FIG. 21B shows low GnP and high GF, FIG. 21C shows high GnP and low GF, and FIG. 21D shows high GnP and high GF.

For the hybrid composites with low concentrations of GnP (i.e., <1 wt. % GnP) and low concentration of GF (i.e., <30 wt. % GF), as shown in FIG. 20A and FIG. 21A, the volume exclusion effect maximizes the potential of the GnPs by bringing those dispersed in the bulk closer to those adhered to the GFs, forming a GnP-based conductive network. The SEM micrographs showcase that the GnPs are either attached directly to the GFs or oriented around them, rather than being uniformly scattered throughout the matrix, boosting the formation of thermal conductive pathways. A similar behavior has been observed, in which the addition of secondary reinforcements promotes the formation of conductive pathways, as a result of the volume exclusion effect, generated by the different geometric fillers. For these composites, the greatest synergistic effect was observed for the hybrid composites containing 0.5 wt. % GnP, which is attributed to the crystalline microstructure with a higher degree of crystallinity (55% compared to 49% of Neat PP), compared to the hybrid composites with 0.25 wt. % GnP. The degree of crystallinity directly affects the thermal conductivity of polymer composites, in which a higher crystallinity results in a greater thermal conductivity.

On the contrary, for the hybrid composites with low concentrations of GnP (i.e., <1 wt. % GnP) and high concentrations of GF (i.e., ³30 wt. % GF), increasing GF content decreases the synergistic effect. However, the degree of crystallinity is only dependent of GnP content, suggesting that it has a minimal contribution to the synergistic effect, as the concentrations of GF increases. As a result, the dominating mechanism contributing to the reduction of the synergistic effect is the insufficient quantity of GnPs, compared to the quantity of GFs, leading to an inability to form continuous thermal conductive pathways as shown in FIG. 20B and FIG. 21B.

For the hybrid composites with high concentrations of GnP (i.e., >1 wt. % GnP) and low concentrations of GF, shown in FIG. 20C and FIG. 21C, the increased concentration of GnP directly induces the formation of conductive pathways, resulting in a less pronounced volume exclusion effect, thereby reducing the overall synergistic effect in these composites. Moreover, these composites are more susceptible to agglomeration due to the higher GnP concentrations, which is detrimental to the phonon transfer through the conductive pathways.

Lastly, for hybrid composites with high concentrations of GnPs and high concentrations of GF, shown in FIG. 20D and FIG. 21D, the synergistic effect begins to increase as this system better exploits the volume exclusion effect compared to the previous scenario, as the GFs force the excess GnPs that are not attached to the GFs, to be confined and oriented along the direction of the fibers. High concentrations of nano-sized fillers preferentially and independently oriented themselves between the spaces of micro-sized fillers, thereby developing network-like pathways. Overall, the synergistic effect for the thermal conductivity of these hybrid composites, is predominately attributed to the volume exclusion effect induced by the GF with a contribution from the degree of crystallinity, at low concentrations of GF.

### 1.3. Conclusion

The examples elucidate how the hybrid approach can produce synergistic effects capable of achieving properties and functionalities not possible in biphasic composites. The synergistic effect for the mechanical properties was attributed to the chemically and/or electrostatically assembled hierarchical reinforcement system, which facilitates load transfer at the interface, due to the increased degree of trans-crystallization and the smaller crystallites with greater surface area. This is accompanied with an increased degree of crystallinity and β-crystal formation, enabling the matrix to absorb a greater amount of energy. It was demonstrated that the optimal concentration of 0.5 wt. %. GnP in the hybrid composites, producing the greatest mechanical properties and synergistic effect, corresponds to the highest degree of crystallinity and peak formation of β-crystals within the PP matrix. Specifically, PPGnP0.5GF50 exceeded the flexural strength of PPGF60 by 3.3% while providing a 9% weight reduction and PPGnP0.5GF40 obtained the same desirable flexural strength as PPGF60, while providing an 18% weight reduction. The same optimal concentration was found to produce the highest synergistic effect for thermal conductivity; however, it was attributed to the joint action of the volume exclusion effect induced by the GFs, and the tailored crystalline microstructure, promoting the formation of thermal conductive pathways. Ultimately, the mechanisms contributing to the synergistic effect presented in this work, can be used to maximize the performance of hybrid composite systems, giving them the potential to be used in a variety of high-performance applications, where mechanical performance, thermal conductivity, and lightweighting are imperative to meet the energy efficiency requirements of the future.

### Example 2

In Example 1, the mold temperature was 80° C. to promote crystallization of samples. In Example 2, a battery encasement (or “battery tub”) was manufactured according to method 200 and injected molded at different temperatures.

### 2.1 Materials and Sample Preparation

A commercially available GnP-PP masterbatch was dry blended with a glass-reinforced-PP. The 30 wt % GNP-PP masterbatch containing graphene nanoplatelets with an average diameter of 38 μm (GrapheneBlack™ 3X), was provided by NanoXplore Inc. (Quebec, Canada)). The glass-reinforced-PP, with commercial name Celstran® PP-GF60-02 Natural, produced by Celanese Corporation (Texas, United States) comprises 60 wt. % of E-glass fibers sized with aminosilane, having an average length of 10 mm and an average diameter of 14 μm, with an overall masterbatch density of 1.43 g/cm³.

Additional polypropylene (PP) homopolymer, HIVAL® 2435, with a melt flow rate of 35 g/10 min (230° C./2.16 kg) and a specific gravity of 0.902 g/cm³ produced by Nexeo Plastics® (Texas, United States) was added to achieve the desired concentrations of GnP and GF, as indicated in Table 2 (below).

After dry-blending the GnP-PP master-batch and glass-reinforced PP, the blended mixture was melt-mixed and injected into a mold using an injection molding machine.

Alternatively, in a development step, Celstran® PP-GF60-02 Natural was replaced with KompoGTe® LE1G60 natural, comprising 60 wt. % of E-glass fibers with a specific gravity of 1.42 g/cm3.

Alternatively, in another development step, KompoGTe® LE1G60 natural was replaced with KompoGTe® LE1G40 natural, comprising 40 wt. % of E-glass fibers with a specific gravity of 1.18 g/cm3. Therefore, HIVAL® 2435 was omitted from the blend to simplify the procedure further.

A 650-ton Kawaguchi KM650B2, model 2003, injection molding machine (Japan), with a 100 mm diameter screw, was used to fabricate an automobile battery encasement particle at a mold temperature of 80° C. or 65° C. . . .

The composites were designated by indicating the matrix, the amount of GnP, and the amount of GF according to this format: PPGnP ζ GF ζ, where the ζ corresponds to the amount of reinforcing material by weight of the whole composite.

### 2.2 Results

Decreasing the injection molding processing cycle time reduced the injection molding processing cycle. As shown in Table 2 below, decreasing the mold temperature from 80° C. to 65° C. caused the cycle time to decrease from 123 seconds to 93 seconds. While the shorter processing cycle might sacrifice crystallization degree in the small articles, for a large article like a battery tub or encasement, the cooling time is sufficiently high to allow for appropriate crystallization and to improve the properties of the manufactured article. Thus, by reducing the mold temperature, the overall manufacturing time and cost can be decreased.

TABLE 2

| Polymer | | | | | |
|---|---|---|---|---|---|
| Composite | Mould | | | | |
| (Automotive | Temper- | Cycle | Flexural | Flexural | |
| Battery | ature | Time | Strength | Toughness | Weight |
| Encasement) | (° C.) | (s) | (MPa) | (MPa) | (kg) |
| PPGF60 | 65 | 93 | 139.16 ± | 2.94 ± | 1.76 |
| | | | 1.49 | 0.26 | |
| PPGF40 | 80 | 123 | 121.88 ± | 3.63 ± | 1.44 |
| | | | 1.20 | 0.52 | |
| PPGF40GnP0.5 | 80 | 123 | 140.63 ± | 3.65 ± | 1.42 |
| | | | 2.68 | 0.18 | |
| PPGF40GnP0.5 | 65 | 93 | 140.67 ± | 3.47 ± | 1.42 |
| | | | 2.16 | 0.42 | |

1. A polymer composite comprising:
a polymer matrix;
greater than 20±1% by weight of the composite of glass fibers; and
between about 0.25±0.01% to 1±0.2% by weight of the composite of graphene nanoplatelets.

2. The polymer composite of claim 1 wherein the glass fibers are silanized and have an average length between 1±0.05 mm and 20±1 mm.

3. (canceled)

4. The polymer composite of claim 2 wherein the glass fibers have an average length of about 10±0.5 mm.

5. The polymer composite of claim 2 wherein the glass fibers have an average diameter of between 4±0.2 μm and 34±1.7 μm.

6. The polymer composite of claim 5 wherein the glass fibers have an average diameter of 14±0.7 μm.

7. The polymer composite of claim 1 wherein the glass fibers comprise between 15±1% and 60%±3% by weight of the composite.

8. (canceled)

9. The polymer composite of claim 2 wherein at least a portion of the graphene nanoplatelets are bound to the glass fibers.

10. The polymer composite of claim 1 wherein an agglomerate flake diameter of the graphene nanoplatelets is between 0.2 and 70 μm.

11. The polymer composite of claim 10 wherein the agglomerate flake diameter of the graphene nanoplatelets is about 38±2 μm.

12. The polymer composite of claim 1 wherein the graphene nanoplatelets comprise between about 1 and about 100 layers of graphene.

13. The polymer composite of claim 12 wherein the graphene nanoplatelets comprise between about 6 and about 10 layers of graphene.

14. The polymer composite of claim 1 wherein the graphene nanoplatelets have a bulk density of 0.18±0.01 g/cm³.

15. (canceled)

16. The polymer composite of claim 1 wherein the polymer composite is characterized by a specific tensile strength greater than 6×10⁴ Pa·m⁴/kg, a flexural strength greater than 90 MPa, and a specific gravity of 1±0.05 g/cm³ to 2±0.1 g/cm³.

17. The polymer composite of claim 1 wherein the polymer matrix comprises a polypropylene with a melt flow rate of about 4 to about 50 g/10 min.

18. The polymer composite of claim 17 wherein the polypropylene comprises a homopolymer with a melt flow rate of 35±2 g/10 min to 70±2 g/10 min.

19.-21. (canceled)

22. The polymer composite of claim 1 wherein:
the glass fibers comprise about 40±2% by weight of the composite; and
the graphene nanoplatelets comprise about 0.5±0.025% by weight of the composite, the graphene nanoplatelets bound to the glass fibers.

23. A component for a vehicle comprising the polymer composite of claim 22.

24. (canceled)

25. A method of preparing a polymer composite, the method comprising the steps of:
melt mixing a polymer matrix with glass fibers and graphene nanoplatelets to create a composition comprising greater than 20% by weight of the composition of the glass fibers, and between 0.1%±0.01% to 5%±1% by weight of the composition of the graphene nanoplatelets; and
injecting the composition into a mold with an injection molding machine.

26. A method of preparing a polymer composite, the method comprising the steps of:
dry blending a first masterbatch including a polymer and glass fibers with a second masterbatch comprising the polymer and graphene nanoplatelets to create a composition comprising greater than 20% by weight of the composition of the glass fibers, and between 0.1%±0.01% to 5%±1% by weight of the composition of the graphene nanoplatelets;
melting mixing the composition with an injection molding machine; and
injecting the composition into a mold with the injection molding machine.

27. The method of claim 26, wherein the mold is shaped to form the composition into a battery encasement.

28.-29. (canceled)
